(19) United States
(12) Patent Application Publication
(10) Pub. No.: US 2006/0219164 A1
(43) Pub. Date: Oct. 5, 2006

(54) Spreading unit for bonding machines, with adhesive recirculation systems

(75) Inventor: Antonio Cerciello, Piacenza (IT)

Correspondence Address: YOUNG & THOMPSON, 745 SOUTH 23RD STREET, 2ND FLOOR, ARLINGTON, VA, 22202, US

(73) Assignee: NORDMECCANICA S.P.A., PIACENZA (IT)

(21) Appl. No.: 11/396,589

(22) Filed: Apr. 4, 2006

(30) Foreign Application Priority Data
Apr. 4, 2005 (IT) PC2005A000018

(51) Int. Cl. B05C 11/02

(52) U.S. Cl. 118/100; 118/249

(57) ABSTRACT

A spreading unit for bonding machines which is equipped with recirculation systems that take up adhesive from the base of the reservoir in contact with the take-up roller and return it to the storage tank, from which it is sent back to the reservoir; this continuous circulation of the product guarantees that the product will maintain the ideal temperature and viscosity characteristics. The reservoir containing the adhesive taken up by the rollers is bounded by a pair of doctor blades which define an enclosed area in contact with the roller and are mounted on a sliding support, so that they can be moved away from the roller for cleaning, maintenance and similar operations. The reservoir is positioned at a height calculated so that adhesive is transferred to the reservoir by a calibrated gravity system, without being engaged by mechanical devices, and consequently without producing foam.

This invention relates to an improved spreading unit for bonding machines which is equipped with recirculation systems that take up adhesive from the base of the reservoir in contact with the take-up roller and return it to the storage tank, from which it is sent back to the reservoir; this continuous circulation of the product guarantees that the product will maintain the ideal temperature and viscosity characteristics.

In accordance with an advantageous aspect of the invention, the reservoir containing the adhesive taken up by the rollers is bounded by a pair of doctor blades which define an enclosed area in contact with the roller and are mounted on a sliding support, so that they can be moved away from the roller for cleaning, maintenance and similar operations.

The spreading unit according to the invention is designed to be installed in a machine used to bond plastic films or spread a reel of paper or film over a thin plastic film.

In said machines, the films to be bonded move at a fairly high speed, generally 3 to 6 metres per second, and a small quantity of adhesive, amounting to approximately 1-3 grams per m², is spread between them.

Spreading the adhesive evenly over the entire surface is obviously a very delicate operation, because the end result and the characteristics of the bonded material depend on it.

The need to spread the adhesive at high speed and with great precision makes this operation very difficult, and the equipment used to perform it must necessarily operate under very precise, controlled conditions.

The spreading devices of known machines comprise a first roller which rotates in contact with a reservoir containing adhesive, collecting a thin layer of adhesive which is transferred to the belt pressed against the film paid out, so as to apply the adhesive to the surface of the film.

The characteristics, and especially the viscosity of the adhesive are of crucial importance, especially in view of the fact that this material is applied to the film in the form of a layer a few microns thick.

To achieve these results all the parameters, especially those relating to the physical characteristics of the adhesive, must be controlled with great precision. Above all the foam that forms during circulation of the adhesive must be eliminated.

For this purpose, adhesive is taken up from the thermostated tanks that keep it at a pre-determined temperature depending on the required viscosity, and is conveyed from said tank, through insulated pipes, to the reservoir; the take-up roller slides in contact with said reservoir.

As this adhesive is taken up from the reservoir, pump systems of known type remove a corresponding quantity of adhesive from the tank and convey it into the reservoir, so that the level is always maintained at the same height and the foam is eliminated with calibrated separators.

In the more recent machines, said reservoir is bounded at the top and bottom by a pair of doctor blades; the roller slides in contact with said doctor blades which, together with the wall on which they are mounted, form the body of the reservoir which is filled with adhesive.

Although adhesive is continuously taken up by the roller and the level in the reservoir is continuously topped up, it is not certain that total, continuous replacement of the product takes place in the reservoir.

The roller may continue to take up adhesive from the surface, whereas the lower layers of adhesive are only taken up to a very small extent, and if the adhesive remains in the reservoir for too long, there is a risk that its properties or parameters, such as temperature, will vary excessively, thus prejudicing the efficient operation of the machine.

These drawbacks are now remedied by the present invention, relating to an improved spreading unit for bonding machines, which includes recirculation devices that continuously take up adhesive from the base of the reservoir and return it to the tank, from which it is pumped back into the reservoir after it has been restored to the ideal temperature. The reservoir is positioned at a height calculated so that adhesive is transferred to the reservoir by a calibrated gravity system, without being engaged by mechanical devices, and consequently without producing foam.

This guarantees continuous recirculation of adhesive without the risk of stagnation which could cause a variation in the characteristics of the compound, and above all without foam production.

Moreover, in accordance with another advantageous aspect of the invention, the reservoir is mounted on a skid that slides along guides integral with the structure of the machine, so that it can be rapidly distanced from the rollers when required for maintenance or cleaning operations.

This invention will now be described in detail, by way of example but not of limitation, by reference to the annexed figures wherein:

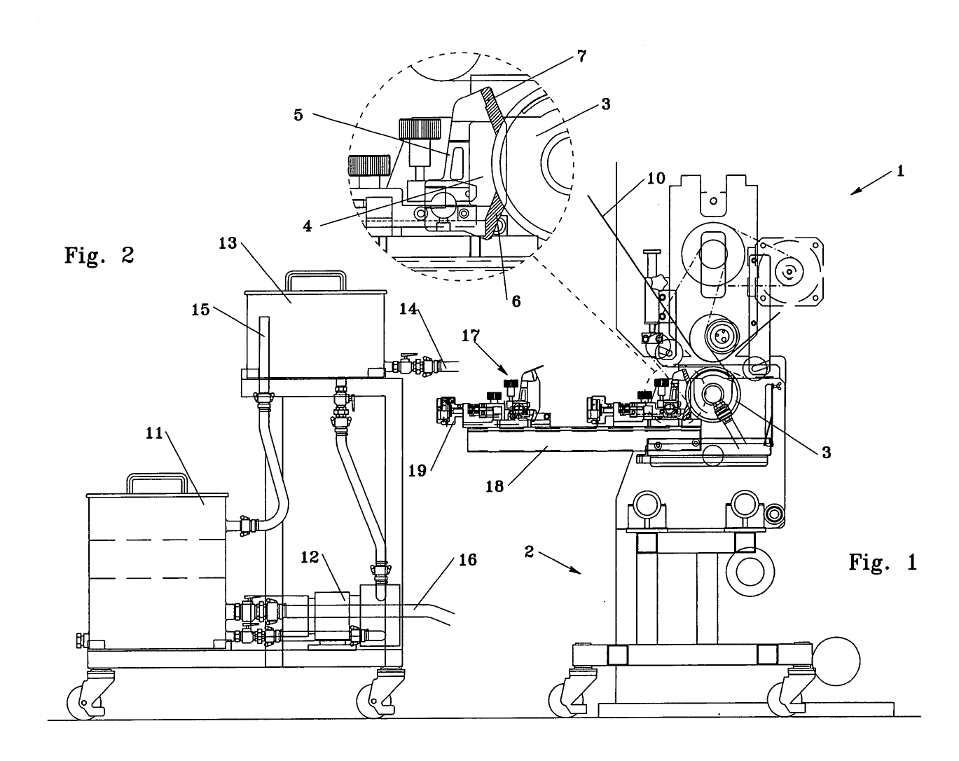

FIG. 1 schematically illustrates the side view of a spreading unit according to the invention;

FIG. 2 is the side view of the adhesive distribution tanks associated with the spreading unit shown in FIG. 1.

In the annexed figures, no. 1 indicates the spreading unit according to the invention, mounted on a carriage 2 which allows it to be rapidly inserted in and removed from the bonding machine.

The spreading unit comprises a first roller or take-up roller 3, usually made of steel, with the surface engraved so as to collect a certain quantity of adhesive, which slides in contact with a reservoir 4 consisting of a support unit 5 for a lower doctor blade 6 and an upper doctor blade 7, which form the lower and upper edges of the reservoir and are maintained in contact with the surface of the roller. The adhesive, possibly after passing over other rollers, is transferred to a film 10, which is paid out by devices not illustrated in the figure.

The adhesive is contained in a tank 11 equipped with thermostating means which maintain it at the temperature needed to ensure the required viscosity.

From tank 11 a peristaltic pump 12 takes up adhesive and delivers it to a second tank 13, in a higher position, from which it is conveyed through an insulated pipe 14 to reservoir 4.

The excess adhesive in tank 13 returns to tank 11 through an overflow 15.

The pump keeps the adhesive constantly in circulation between the two tanks, so that there is always adhesive in tank 13 at the necessary temperature and with the head required to ensure suitable transfer to reservoir 4.

In accordance with one characteristic of the invention, adhesive is returned to pump 12 and then back to tank 11 through a pipe 16 which passes through openings in the base of reservoir 4.

With this system, the adhesive in the reservoir is also kept constantly in circulation, preventing part of it from producing foam or breaking down, due to causes such as temperature variations, or after stagnation, for example in the corners of the reservoir.

In accordance with a further advantageous characteristic of the invention, the unit that constitutes the reservoir, shown as 17 in FIG. 1, is mounted on a slide 18 and can be moved, for example, by means of a worm rack system 19 or other known system, to distance it from roller 3.

This gives easy access to the interior of the reservoir and the roller surface for the necessary periodic cleaning operations.

During operation of the machine, unit 17 approaches roller 3 until doctor blades 5 and 6 are in contact with its surface. Once the adhesive has been brought to the correct temperature, the pump that transfers it to tank 13 is activated, and it is conveyed from there into reservoir 4.

When said reservoir is full the machine can be started up, and the rollers will take up a layer of adhesive and distribute it on the film.

As only a minimal quantity of adhesive is taken up, to prevent the adhesive from remaining in the reservoir for an excessively long time, with the risk that the temperature falls, it is taken up from the base of the reservoir and returned to tank 11 by pump 12, while fresh adhesive is simultaneously fed through pipe 14, creating a continuous circulation which ensures that there is fresh adhesive in the reservoir at all times.

Moreover, as the adhesive is transferred from tank 13 to reservoir 4 by gravity, without the use of mechanical handling devices, there is no risk of foam formation in the product conveyed to the reservoir.

At the end of processing it is sufficient to activate the worm rack system to distance unit 17 from the cylinder, thus giving easy access to the interior for cleaning purposes.

As clearly appears from the description supplied, the spreading unit according to the invention ensures that the adhesive is always in the ideal conditions, thus guaranteeing perfect spreading, as well as the practicality deriving from convenient, easy access to the internal parts for cleaning.

An expert in the field could devise various modifications and variations, all of which should be deemed to fall within the ambit of this invention.

1) Improved spreading unit for bonding machines, of the type comprising at least one roller (3) in contact with an adhesive reservoir (4) and a roller that slides in contact with a film on which said adhesive is to be deposited, characterised in that adhesive recirculating systems are fitted in the take-up reservoir.

2) Spreading unit as claimed in claim 1, characterised in that said reservoir (4) is bounded above and below by a pair of doctor blades (5, 6) in contact with take-up roller (3), pipes being fitted at the base of said reservoir which place the interior of the reservoir in communication with a pump (12) designed to pump the adhesive to the starting tank.

3) Spreading unit as claimed in claim 1, characterised in that it includes a first adhesive tank (11), a second tank (13) installed at a higher level than reservoir (4), and pipes (14) designed to transfer the adhesive from said second tank (13) to said reservoir (4) by gravity.

4) Spreading unit as claimed in claim 3, characterised in that said pipes (14) for the transfer of adhesive to reservoir (4) are thermostated.

5) Spreading unit as claimed in claim 3, characterised in that said second tank (13) is fitted with means designed to transfer the excess adhesive to said first tank (11).

6) Spreading unit as claimed in claim 4, characterised in that said reservoir (4) is mounted on a support (17) which slides in relation to said roller (3), and that said unit is equipped with means designed to control its movements between an operational position in which the doctor blades (5, 6) of said reservoir are in contact with the surface of the take-up roller (3) and a more distant position, in which access to the inner parts is facilitated.

7) Spreading unit as claimed in claim 2, characterised in that it includes a first thermostatated tank (11) containing adhesive; a second thermostated tank (13), in a raised position in relation to reservoir (4) in contact with adhesive take-up roller (3), means (12) designed to transfer adhesive from said first tank to said second tank, and means designed to circulate adhesive between said reservoir and said tanks.

8) Spreading unit as claimed in claim 6, characterised in that said reservoir (4) is mounted on devices designed to allow its movement from an operational position, in which the reservoir is in contact with take-up roller (3), to a position in which the reservoir moves away from said roller (3) to allow access to the internal parts.
